(19) United States
(12) Patent Application Publication
(10) Pub. No.: US 2018/0204423 A1
(43) Pub. Date: Jul. 19, 2018

(54) AUTOMATIC TRANSACTION SYSTEM

(71) Applicant: HITACHI-OMRON TERMINAL SOLUTIONS, CORP., Tokyo (JP)

(72) Inventors: Eiji MIZUNO, Tokyo (JP); Hisao OGATA, Tokyo (JP)

(73) Assignee: HITACHI-OMRON TERMINAL SOLUTIONS, CORP., Tokyo (JP)

(21) Appl. No.: 15/744,767

(22) PCT Filed: Dec. 25, 2015
(86) PCT No.: PCT/JP2015/086412

§ 371 Date: Jan. 13, 2018

(51) Int. Cl. G07F 19/00; H04L 9/06; G06F 21/56

(52) U.S. Cl. CPC G07F 19/202; G06F 21/56; H04L 9/0643; G07F 19/203

(57) ABSTRACT

A highly reliable automatic transaction system is capable of minimizing damage caused by malware. In an automatic transaction system, a first storage unit stores first transaction information in a paper currency transaction device and a second storage unit stores first transaction information in an external device. In a second transaction, a transaction after a first transaction, an ATM control unit sends second transaction information as information related to an amount to be handled in the second transaction, an external device sends the first transaction information from the second storage unit, and the paper currency handling device receives the second transaction information, and the external device sends the first transaction information, and determines whether the first transaction information stored in the first storage unit and the first transaction information sent by the external device are a match. When a match occurs paper currencies are transferred based on the second amount information.

### TECHNICAL FIELD

The present invention relates to an automatic transaction system and, for example, can be suitably applied to an automatic transaction system which performs deposit/withdrawal transactions based on information recorded on credit cards and cash cards and operations of users.

### BACKGROUND ART

Conventionally, as methods of detecting unauthorized transactions that are executed in an automatic transaction device such as an ATM (Automated Teller Machine), known are the methods disclosed in PTL 1 and PTL 2. Specifically, PTL 1 describes a technology of confirming whether or not the arithmetic error in the sales calculation of paper currencies stored in the deposit/withdrawal device installed in a store or the like involves the user's fraudulence. Moreover, PTL 2 describes a technology of comparing the log data of transactions, automatically detecting suspicious forms of transactions in comparison to the behavior of the user using the automatic transaction device, and taking measures according to the respective cases.

### CITATION LIST

### Patent Literature

[PTL 1] Japanese Patent Application Publication No. 2013-171313
[PTL 2] Japanese Patent Application Publication No. 2007-199881

### SUMMARY OF THE INVENTION

### Problems to be Solved by the Invention

Meanwhile, an ATM control unit which controls the overall automatic transaction device is loaded with application software and control software for controlling a paper currency deposit/withdrawal mechanism, but when the foregoing software is taken over by malware, there is a possibility that an unauthorized withdrawal command will be sent to the paper currency deposit/withdrawal mechanism, and unauthorized withdrawal processing will be executed based on such unauthorized withdrawal command. Furthermore, in the case of a deposit transaction, the malware may increase the deposited amount to be greater than the actual number of paper currencies deposited in the automatic transaction device, and fraudulently increase the account balance.

Particularly, in recent years, the imitative techniques of malware (Malicious Software) are becoming sophisticated, and causing problems in various information system industries. It is necessary to anticipate cases where the invasion of malware is allowed through circumvention of defensive measures caused by human-caused management errors, and the damage will spread from the discovery of the malware until measures are taken because time is required for taking measures against newly created malware and incorporating such measures into the system.

The present invention was devised in view of the foregoing points, and an object of this invention is to provide a highly reliable automatic transaction system capable of minimizing the damage caused by malware.

### Means to Solve the Problems

In order to achieve the foregoing object, the present invention provides an automatic transaction system which performs transactions using paper currencies, comprising: an ATM control unit which sends first transaction information including first amount information as information related to an amount to be handled in a first transaction; a paper currency handling device which receives the first transaction information and transfers paper currencies based on the first amount information included in the first transaction information; a first storage unit which is provided in the paper currency handling device and which stores the first transaction information received by the paper currency handling device; and a second storage unit which is provided in an external device outside the paper currency handling device and which stores the first transaction information received by the external device, wherein, in a second transaction which is a transaction after the first transaction, the ATM control unit sends second transaction information including second amount information as information related to an amount to be handled in the second transaction, the external device sends the first transaction information stored in the second storage unit, and the paper currency handling device: receives the second transaction information, and the first transaction information sent by the external device; and determines whether or not the first transaction information stored in the first storage unit and the first transaction information sent by the external device are a match, and, when they are a match, transfers paper currencies based on the second amount information included in the second transaction information.

According to the automatic transaction system of the present invention, even when the ATM control unit is infected with malware and the unauthorized second transaction information is sent to the paper currency handling device, because the malware does not retain the first transaction information, the paper currency handling device will not transfer the paper currency according to the second transaction information. Moreover, even if the malware is equipped with a function of intercepting and recording transaction information, because there will be an inconsistency between the first transaction information that is stored in the first storage unit during the subsequent normal transaction and the first transaction information that is sent from the ATM control unit to the paper currency handling device, it is possible to detect that an unauthorized transaction was conducted until the next normal transaction is performed.

### Advantageous Effects of the Invention

According to the present invention, it is possible to realize a highly reliable automatic transaction system capable of minimizing the damage caused by malware.

### BRIEF DESCRIPTION OF DRAWINGS

FIG. 1 is a block diagram showing an overall configuration of the automatic transaction system according to the first to third embodiments.

FIG. 2 is a conceptual diagram showing a configuration of the transaction information table according to the first to third embodiments.

FIG. 3 is a sequence diagram showing a flow of the initialization processing.

FIG. 4 is a sequence diagram showing a flow of the withdrawal transaction processing according to the first embodiment.

FIG. 5 is a conceptual diagram explaining a case where an unauthorized transaction was conducted.

FIG. 6 is a sequence diagram showing a flow of the unauthorized command detection processing according to the second embodiment.

FIG. 7 is a flowchart explaining the third embodiment.

FIG. 8 is a block diagram showing an overall configuration of the automatic transaction system according to the fourth embodiment.

FIG. 9 is a sequence diagram showing a flow of the withdrawal transaction processing according to the fourth embodiment.

FIG. 10 is a conceptual diagram showing a configuration of the transaction information table according to the fourth embodiment.

### DESCRIPTION OF EMBODIMENTS

An embodiment of the present invention is now explained in detail with reference to the appended drawings.

### (1) First Embodiment

### (1-1) Configuration of Automatic Transaction System of this Embodiment

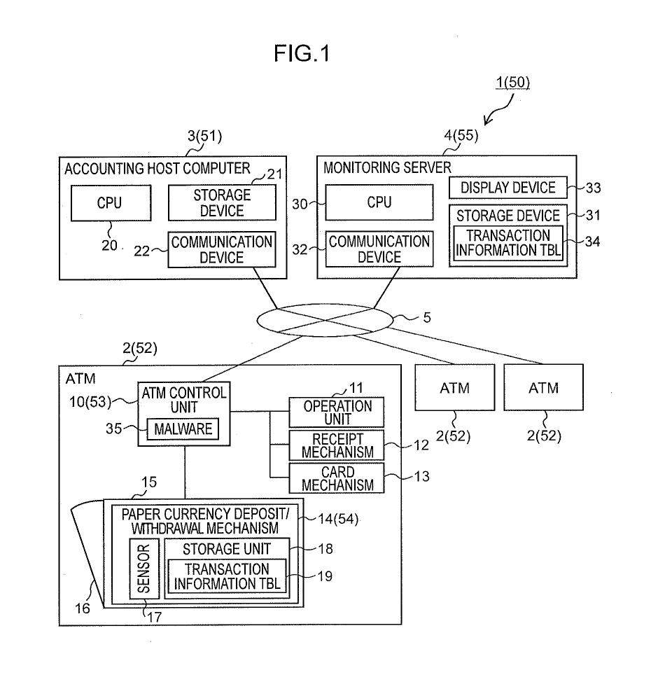

In FIG. 1, reference numeral 1 represents the overall automatic transaction system according to this embodiment. The automatic transaction system 1 comprises one or more ATMs 2, an accounting host computer 3 and a monitoring server 4, and is configured by the foregoing components being connected via a wide area network 5 such as a LAN (Local Area Network) or a WAN (Wide Area Network).

The ATM 2 is an automatic transaction device which performs transactions of deposit/withdrawal according to the user's operation. The ATM 2 comprises internal devices such as an ATM control unit 10, an operation unit 11, a receipt mechanism 12, a card mechanism 13 and a paper currency deposit/withdrawal mechanism 14.

The ATM control unit 10 is hardware that governs the operational control of the overall ATM 2. In effect, the ATM control unit 10 has a computer configuration comprising information processing resources such as a CPU (Central Processing Unit), a memory and a communication device, and various types of processing are executed as the overall ATM 2 by the CPU controlling the internal devices such as the operation unit 11, the receipt mechanism 12, the card mechanism 13 and the paper currency deposit/withdrawal mechanism 14 based on the programs stored in the memory.

The operation unit 11 comprises a touch panel or the like, receives the user's operational input that is performed according to the various types of operation guides displayed on the touch panel, and notifies the received operational input to the ATM control unit 10. The receipt mechanism 12 is an internal device with a function of printing the transaction details notified from the ATM control unit 10 on a receipt, and discharging the receipt from a receipt discharge unit (not shown) provided to the front face of the ATM 2.

The card mechanism 13 is configured from a card reader or the like, and has a function of incorporating into the ATM 2 a card medium such as a cash card inserted into a card insertion slot (not shown) provided to the front face of the ATM 2, reading necessary information such as the user's account number from the card medium and notifying the information to the ATM control unit 10, and discharging the card medium, which was incorporated into the ATM 2, from the card insertion slot described above.

Moreover, the paper currency deposit/withdrawal mechanism 14 is an internal device that functions as a paper currency handling device which transfers paper currencies and performs the deposit/withdrawal of cash. The paper currency deposit/withdrawal mechanism 14 is protected by being disposed within a cashbox 15, and the cashbox 15 is provided with a cashbox door 16 which is opened/closed upon depositing/paying out the paper currencies handled by the paper currency deposit/withdrawal mechanism 14. The paper currency deposit/withdrawal mechanism 14 is provided with a sensor 17 as a detection unit which detects an open/closed state of the cashbox door 16.

Note that, in the case of this embodiment, the paper currency deposit/withdrawal mechanism 14 is provided with a storage unit 18 configured from a semiconductor memory or a hard disk device, and a transaction information table 19 storing log information which represents the transaction details of the respective transactions executed in the ATM 2 (this is hereinafter referred to as the “transaction information”) is retained in the storage unit 18.

Meanwhile, the accounting host computer 3 is a computer device with a function of storing and managing various types of information related to the account and balance of the user of the ATM 2 as an upper-level device of the ATM 2, and is configured by comprising information processing resources such as a CPU 20, a storage device 21 and a communication device 22.

The CPU 20 is a processor that governs the operational control of the overall accounting host computer 3. Moreover, the storage device 21 is configured from a semiconductor memory and a hard disk device, and is mainly used for storing programs and necessary information. Various types of processing are executed as the overall accounting host computer 3 by the CPU 20 executing the programs stored in the storage device 21. The communication device 22 is configured, for example, from an NIC (Network Interface Card), and performs protocol control during communication with each ATM 2 and the monitoring server 4 via the wide area network 5.

The monitoring server 4 is a general-purpose server device with a function of monitoring the transactions executed in the respective ATMs 2, and is configured by comprising information processing resources such as a CPU 30, a storage device 31, a communication device 32 and a display device 33. Because the function and configuration of the CPU 30, the storage device 31 and the communication device 32 are the same as the corresponding components of the accounting host computer 3 (CPU 20, storage device 21 or communication device 22), the explanation thereof is omitted. The display device 33 is configured, for example, from a liquid crystal display or an organic EL (Electro Luminescence) display, and is used for displaying various types of information.

The storage device 31 of the monitoring server 4 retains a transaction information table 34 which stores all transaction information representing the details of each transaction (withdrawal transaction in the ensuing explanation) which was permitted by the accounting host computer 3 to each ATM 2 as described later. The transaction information is based on the details notified from the accounting host computer 3 when the accounting host computer 3 sends a command permitting withdrawal (a command including the denomination and number of paper currencies to be paid out; this is hereinafter referred to as the “withdrawal command”) to the ATM 2, and is based on the same data format as each piece of transaction information registered in the transaction information table 19 which is stored in the storage unit 18 of the paper currency deposit/withdrawal mechanism 14 of the ATM 2.

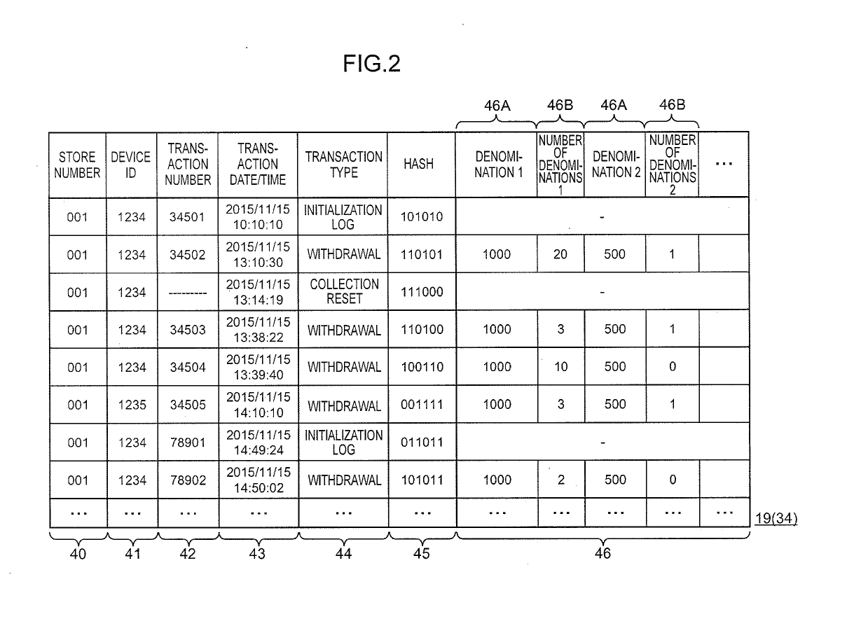

The configuration of the transaction information table 19 stored in the storage unit 18 of the paper currency deposit/withdrawal mechanism 14 of the ATM 2 and the transaction information table 34 stored in the storage device 31 of the monitoring server 4 is shown in FIG. 2. Each line of the transaction information table 19, 34 corresponds to the transaction information representing the details of one transaction.

The transaction information table 19, 34 is configured by comprising a store number column 40, a device ID (Identification) column 41, a transaction number column 42, a transaction date/time column 43, a transaction type column 44, a hash value column 45 and an amount column 46.

The store number column 40 stores a number (store number) which is assigned to a store, and which is also unique to that store, where the ATM 2 that conducted the target transaction was conducted is installed, and the device ID column 41 stores an identifier (device ID) which is assigned to the ATM 2 that conducted the transaction, and which is also unique to that ATM 2. Moreover, the transaction number column 42 stores a number (transaction number) which is assigned to each transaction, and which is also unique to that transaction. In the case of this embodiment, the transaction number assigned by the accounting host computer 3 to that transaction according the processing request from the ATM control unit 10 is used as the transaction number of that transaction.

The transaction date/time column 43 stores a date/time (transaction date/time) that the transaction was performed, and the transaction type column 44 stores a type (transaction type) of the transaction. As the transaction type, there are, for example, “withdrawal”, “collection reset” and “initialization log”. “Withdrawal” represents a withdrawal transaction, and “collection reset” represents that the transaction information is dummy transaction information to be registered when the paper currencies in the cashbox 15 (FIG. 1) of the ATM 2 are collected. Moreover, “initialization log” represents that the transaction information is dummy transaction information to be registered when the ATM 2 is installed, or when the storage unit 18 (FIG. 1) of the paper currency deposit/withdrawal mechanism 14 (FIG. 1) of the ATM 2 is replaced due to a malfunction or other reasons.

Furthermore, the amount column 46 is provided with a denomination column 46A in correspondence with each type (denomination) of paper currency that is issued in that country, and also provided with a number of denominations column 46B in correspondence with each denomination column 46A, and stores an amount of the denominations corresponding to the denomination column 46A, and stores the number of denominations that were deposited/paid out in the transaction corresponding to the number of denominations column 46B.

Furthermore, the hash value column 45 stores a hash value generated from information such as the store number, device ID, transaction number, transaction date/time, transaction type and amount of the corresponding transaction. The hash value is calculated by using, for example, a common hash function such as SHA (Secure Hash Algorithm)-1 or SHA-2 in the paper currency deposit/withdrawal mechanism 14 of the ATM 2 or the monitoring server 4 as described later. By way of reference, when the transaction type is “initialization log” or “collection reset”, the information is omitted because there is no denomination or number of denominations.

Note that, while the transaction information table 34 retained in the storage device 31 of the monitoring server 4 stores all transaction information of the transactions conducted in the respective ATMs 2 within the automatic transaction system 1, it should be understood that FIG. 2 displays an extraction of only the transaction information of one ATM 2 (in the case of FIG. 2, the ATM 2 having a device ID of “1234”) among the respective ATMs 2.

### (1-2) Transaction Monitoring Function in Automatic Transaction System

The transaction monitoring function executed in the automatic transaction system 1 of this embodiment is now explained. Foremost, considered is a case where the ATM control unit 10 (FIG. 1) of the ATM 2 is infected with malware from any cause, and consequently an unauthorized withdrawal command is sent from the ATM control unit 10 to the paper currency deposit/withdrawal mechanism 14 (FIG. 1) and an unauthorized withdrawal transaction is performed due to the malware.

In the foregoing case, because the unauthorized withdrawal transaction is not executed based on a withdrawal command from the accounting host computer 3, there will be an inconsistency between the transaction information of the transactions executed in each of the ATMs 2 accumulated in the storage device 31 (FIG. 1) of the monitoring server 4, and the transaction information of the respective transactions executed in that ATM 2 accumulated in the storage unit 18 of the paper currency deposit/withdrawal mechanism 14.

Thus, in the automatic transaction system 1, when the accounting host computer 3 sends a withdrawal command to the ATM 2, the accounting host computer 3 also sends to that ATM 2 the transaction information of the last transaction that was executed by that ATM 2 based on the withdrawal command from the accounting host computer 3 which is retained in the storage device 31 of the monitoring server 4.

Meanwhile, in the ATM 2, the paper currency deposit/withdrawal mechanism 14 compares the received transaction information of the last transaction and the transaction information of the last transaction stored in the storage unit 18, and executes the transaction only when they are a match. When the transaction information is a mismatch, the paper currency deposit/withdrawal mechanism 14 cancels the transaction and notifies an abnormality to the outside.

Details of the various types of processing that are executed in the automatic transaction system 1 in relation to the foregoing transaction monitoring function are now explained.

### (1-2-1) Initialization Processing

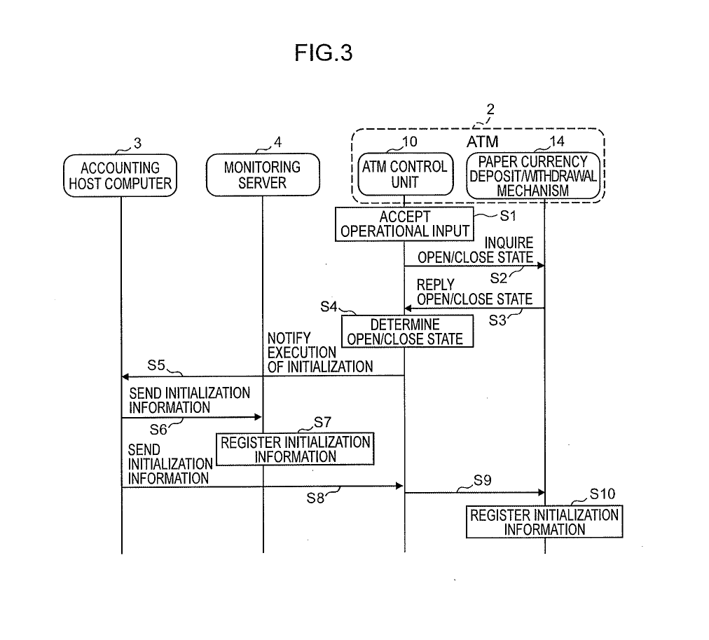

FIG. 3 shows a processing routine of the initialization processing that is executed before operating a newly installed ATM 2.

After a new ATM 2 has been installed, a clerk foremost performs an operational input to the effect of executing initialization via the operation unit 11 of that ATM 2. Subsequently, when the ATM control unit 10 of the ATM 2 receives the operational input, the ATM control unit 10 accepts the operational input (51), and makes an inquiry to the paper currency deposit/withdrawal mechanism 14 on whether or not the cashbox door 16 (FIG. 1) of the cashbox 15 (FIG. 1) is open (S2).

This confirmation is performed for verifying that an authorized clerk is present for the initialization, and in this embodiment, let it be assumed that the clerk allowed to access the cash in the cashbox 15 is authorized to perform the initialization as the administrator of the paper currencies in the cashbox 15. However, for instance, the authority of the clerk may also be verified based on a separate means such as a password.

Subsequently, when the ATM control unit 10 receives a reply from the paper currency deposit/withdrawal mechanism 14 in response to the inquiry (S3), the ATM control unit 10 determines the open/closed state of the cashbox door 16 of the cashbox 15 based on the reply (S4). When the ATM control unit 10 determines that the cashbox door 16 is closed, the ATM control unit 10 determines that a clerk authorized to perform initialization is not present, and ends the initialization processing. Accordingly, in the foregoing case, it is not possible to perform the initialization of the ATM 2.

Meanwhile, when the ATM control unit 10 determines that the cashbox door 16 of the cashbox 15 is open in step S4, the ATM control unit 10 notifies the accounting host computer 3 that the initialization will be executed (S5).

Subsequently, the accounting host computer 3 that received the foregoing notification generates dummy transaction information to be used in the initialization (this is hereinafter referred to as the “initialization information”). The initialization information is information in which the hash value has been excluded from the transaction information of a line in which the transaction type is “initialization log” in FIG. 2. The accounting host computer 3 thereafter sends the generated initialization information to the monitoring server 4 (S6). Consequently, the monitoring server 4 that received the initialization information calculates the hash value of the received initialization information (store number, device ID, transaction number, transaction date/time and transaction type), and registers the initialization information, including the calculated hash value, in the transaction information table 34 of the storage device 31 (S7).

Moreover, the accounting host computer 3 sends the initialization information to the ATM 2 that notified the execution of initialization in step S5 (S8). Consequently, when the ATM control unit 10 of that ATM 2 receives the initialization information, the ATM control unit 10 transfers the received initialization information to the paper currency deposit/withdrawal mechanism 14 (S9). Moreover, the paper currency deposit/withdrawal mechanism 14 that received the initialization information calculates the hash value of the received initialization information by using the same hash function as the monitoring server 4, and registers the initialization information, including the calculated hash value, in the transaction information table 19 stored in the storage unit 18 (S10).

The series of initialization processing is thereby ended.

### (1-2-2) Withdrawal Transaction Processing

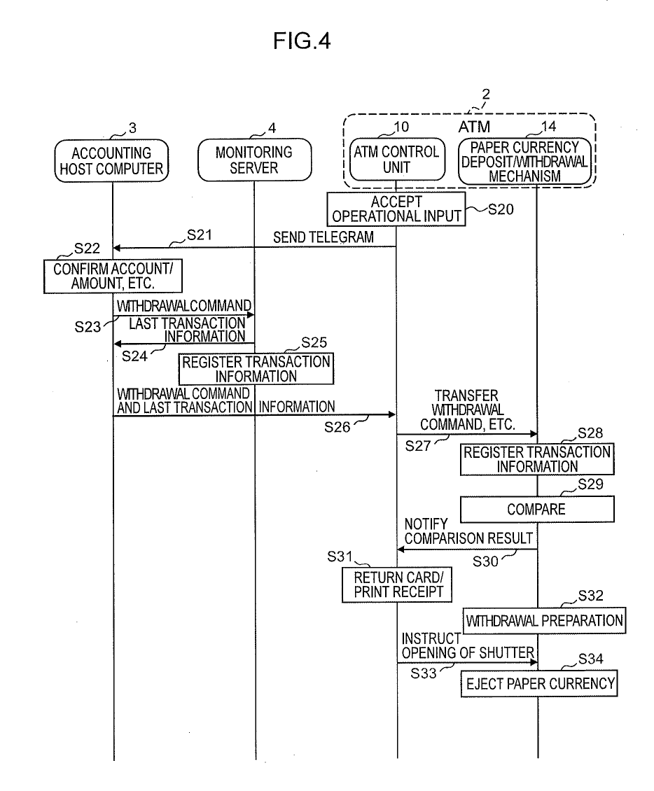

Meanwhile, FIG. 4 shows a processing routine of the withdrawal transaction processing that is executed in the automatic transaction system 1 when a user performs a withdrawal transaction operation to the ATM 2.

When a user inserts a card medium such as a cash card and operates the operation unit 11 to input necessary information such as his/her personal identification number and transaction amount and thereafter touches the confirmation button displayed on the operation unit 11, the ATM control unit 10 of the ATM 2 accepts the operational input (S20), generates a telegram of a processing request including information required for the withdrawal transaction such as the user's account number and transaction amount which was read from the card medium by the card mechanism 13, and sends the generated telegram to the accounting host computer 3 (S21).

When the accounting host computer 3 receives the telegram, the accounting host computer 3 refers to a database (not shown) and confirms the user's account number and balance after the transaction (S22), and, when the transaction is possible, generates a withdrawal command including the store number, device ID, transaction number, transaction date/time and transaction type described above with reference to FIG. 2, and the denominations and the number of denominations upon paying out the requested amount, and sends the generated withdrawal command to the monitoring server 4 (S23).

The monitoring server 4 that received the withdrawal command reads, from the transaction information table 34 stored in the storage device 31, the transaction information related to the last transaction executed in the ATM 2 in which the withdrawal transaction operation was performed, and sends the read transaction information to the accounting host computer 3 (S24). Moreover, the monitoring server 4 thereafter calculates the hash value described above with reference to FIG. 2 based on the store number, device ID, transaction number, transaction date/time and transaction type, and the denominations and the number of denominations upon paying out the requested amount included in the withdrawal command, and registers information such as the store number and device ID included in the hash value, as the transaction information of the withdrawal transaction to be executed, in the transaction information table 34 (S25).

Meanwhile, the accounting host computer 3 that acquired the transaction information of the last transaction from the monitoring server 4 as described above sends that transaction information, and a withdrawal command that is the same as the withdrawal command sent to the monitoring server 4 in step S23, to the ATM 2 in which the withdrawal transaction operation was performed (S26).

The ATM control unit 10 of the ATM 2 that received the withdrawal command and the transaction information of the last transaction transfers the received withdrawal command and transaction information of the last transaction to the paper currency deposit/withdrawal mechanism 14 (S27).

Subsequently, the paper currency deposit/withdrawal mechanism 14 that received the withdrawal command and the transaction information of the last transaction calculates the hash value described above with reference to FIG. 2 by using the same hash function that was used when the monitoring server 4 calculated the hash value in step S25 based on the store number, device ID, transaction number, transaction date/time and transaction type, and the denominations and the number of denominations upon paying out the requested amount included in the withdrawal command, and registers the calculated hash value and information such as the store number and device ID included in the withdrawal command, as the transaction information of the withdrawal transaction to be executed, in the transaction information table 19 stored in the storage unit 18 (S28).

Moreover, the paper currency deposit/withdrawal mechanism 14 thereafter compares the hash value included in the transaction information of the last transaction that was sent together with the withdrawal command and the hash value included in the transaction information of the last transaction executed by that ATM 2 which is stored in the transaction information table 19 (S29), and notifies the comparison result (match or mismatch) to the ATM control unit 10 (S30). Moreover, the paper currency deposit/withdrawal mechanism 14 performs a withdrawal preparation of discharging, to the paper currency outlet, the paper currencies of the respective denominations designated in the withdrawal command in the number of denominations designated in the withdrawal command only when the two hash values are a match (S32).

Meanwhile, when the comparison result from the paper currency deposit/withdrawal mechanism 14 indicates that the two hash values are not a match, the ATM control unit 10 determines that the present transaction may be an unauthorized transaction, cancels the present transaction and notifies an abnormality to the outside. Here, the notification of an abnormality to the outside is a notification to the user or the clerk that the transaction information stored in the storage device 31 of the monitoring server 4 and the corresponding transaction information stored in the storage unit 18 of the paper currency deposit/withdrawal mechanism 14 are not a match, and includes a buzzer, illumination of an abnormality lamp, and transmission of abnormality information to the monitoring server. The same applies in the ensuing explanation.

Meanwhile, when the comparison result from the paper currency deposit/withdrawal mechanism 14 indicates that the two hash values are a match, the ATM control unit 10 controls the card mechanism 13 (FIG. 1) to return the user's card medium, which had been inserted, to the user, and controls the receipt mechanism 12 (FIG. 1) to print the details of the present transaction on a receipt (S31).

Furthermore, the ATM control unit 10 instructs the paper currency deposit/withdrawal mechanism 14 to open the shutter which is blocking the paper currency outlet (not shown) (S33). Consequently, the paper currency deposit/withdrawal mechanism 14 discharges the paper currencies by opening the shutter according to the foregoing instruction (S34), and thereafter closes the shutter once the paper currencies are removed by the user. The series of withdrawal processing is thereby ended.

### (1-3) Effect of this Embodiment

As described above, with the automatic transaction system 1, the transaction information of the respective transactions executed in the ATM 2 is accumulated in the storage device 31 of the monitoring server 4 and in the storage unit 18 of the paper currency deposit/withdrawal mechanism 14 of that ATM 2, when the accounting host computer 3 sends a withdrawal command to the ATM 2, the accounting host computer 3 also sends to that ATM 2 the transaction information of the last transaction executed by that ATM 2 which is stored in the storage device 31 of the monitoring server 4, and the paper currency deposit/withdrawal mechanism 14 of the ATM 2 compares the hash value included in that transaction information and the hash value included in the transaction information of the last transaction stored in the storage unit 18, and, when the hash values do not match, cancels the transaction and notifies an abnormality to the outside.

Here, for example, in the case of FIG. 2, let it be assumed that the ATM 2 was operating normally up to transaction number “34504”, but the ATM control unit 10 was subsequently infected with malware 35 (FIG. 1) due to some kind of event, and the malware 35 is now able to issue a fraudulent withdrawal command to the paper currency deposit/withdrawal mechanism 14.

In the foregoing case, in order for the malware 35 to issue a fraudulent withdrawal command and execute an unauthorized withdrawal transaction, the transaction information of the last transaction that was executed the ATM 2 is required, but the malware 35 does not retain such transaction information. Thus, even if the malware 35 issues a fraudulent withdrawal command to the paper currency deposit/withdrawal mechanism 14, in the comparison of the two hash values executed in the paper currency deposit/withdrawal mechanism 14 (step S29 of FIG. 4), a comparison result to the effect that the two hash values do not match will be obtained, and an unauthorized withdrawal transaction will never be concluded.

Moreover, it is also possible to assume a case where the malware 35 somehow acquires the transaction information including the hash value retained by the monitoring server 4 based on some kind of unauthorized method. In the foregoing case, as a result of the malware 35 sending the transaction information of the last transaction and the withdrawal command to the paper currency deposit/withdrawal mechanism 14, an unauthorized withdrawal transaction will be concluded.

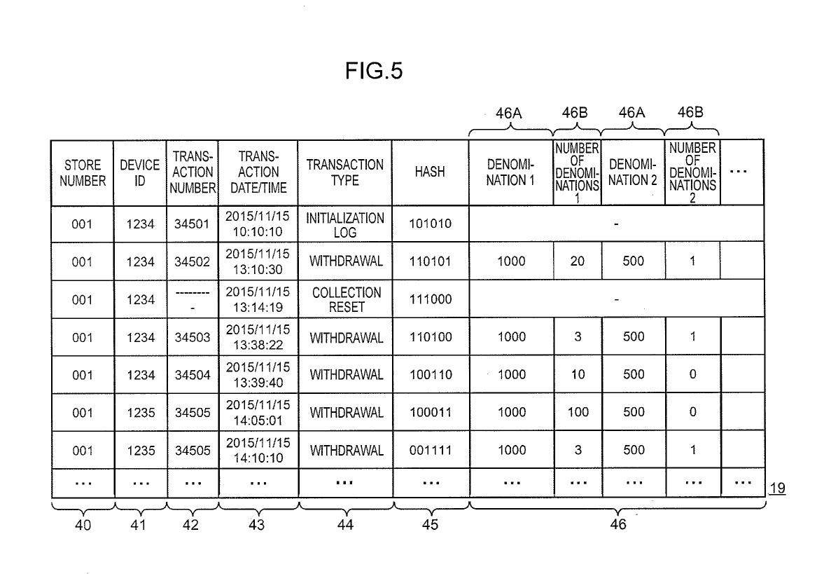

Nevertheless, in the foregoing case, as shown in FIG. 5, because the transaction information related to the unauthorized withdrawal transaction (transaction information in which the transaction date/time is “2015/11/15 14:10:10” and the transaction number is “34505”) will remain in the transaction information table 19 of the paper currency deposit/withdrawal mechanism 14, when a normal withdrawal command and the transaction information of the last transaction are thereafter sent from the accounting host computer 3, the hash value included in the transaction information of the last transaction sent from the accounting host computer 3 (in the example of FIG. 5, transaction information in which the transaction date/time is “2015/11/15 13:39:40” and the transaction number is “34504”) and the hash value included in the transaction information of the last transaction retained in the transaction information table 19 which is stored in the paper currency deposit/withdrawal mechanism 14 (transaction information related to the unauthorized withdrawal transaction in which the transaction date/time is “2015/11/15 14:10:10” and the transaction number is “34505” in FIG. 5) will not match, and it is thereby possible to detect that an unauthorized transaction was conducted in the past.

Thus, according to the automatic transaction system 1, even if the ATM control unit 10 of the ATM 2 is infected with malware 35, it is possible to effectively prevent an unauthorized transaction from being executed by the malware 35, and, even if the malware 35 is of a type which records and retains the withdrawal commands from the accounting host computer 3, it is possible to detect that an unauthorized transaction was executed when a normal transaction is subsequently executed. Consequently, according to this embodiment, it is thereby possible to realize a highly reliable automatic transaction system capable of minimizing the damage of unauthorized processing caused by the malware 35.

### (2) Second Embodiment

With the automatic transaction system 1 of the first embodiment, upon sending a withdrawal command to the ATM 2, because the accounting host computer 3 always sends the transaction information of the last transaction executed by the ATM 2 in addition to the withdrawal command, the amount of change in the existing communication protocol of the communication performed between the accounting host computer 3 and the respective ATMs 2 will increase.

Meanwhile, with an ATM 2, a detailed examination (verification of match) of the cash retained internally and the cash that should be retained by that ATM 2 as recorded in the accounting host computer 3 is generally performed at a frequency of once every few days to once a week. When this detailed examination is performed, cash is removed from the ATM 2 and a spot check of the cash is performed using a counting machine or the like. Here, if the cash removed from the ATM 2 and the cash recorded in the accounting host computer 3 do not match, there is a possibility that cash was fraudulently removed.

In the foregoing case, the mismatch between the cash removed from the ATM 2 and the cash recorded in the accounting host computer 3 could be a result of the theft of cash in addition to the issue of an unauthorized command by the malware 35. Thus, based on the foregoing mismatch alone, it is not possible to detect the issue of an unauthorized command by the malware 35. Nevertheless, by comparing the transaction information registered in the transaction information table 34 retained by the monitoring server 4 and the transaction information registered in the transaction information table 19 retained by the paper currency deposit/withdrawal mechanism 14, it is possible to easily verify whether or not an unauthorized command was issued by the malware 35 in the past in the same manner as the first embodiment.

In light of the foregoing point, in this embodiment, the transaction information of the past transaction executed in the ATM 2 which is stored in the transaction information table 34 retained by the monitoring server 4 and the transaction information registered in the transaction information table 19 retained by the paper currency deposit/withdrawal mechanism 14 of that ATM 2 are compared at the timing that the detailed examination of that ATM 2 is performed. It is thereby possible to detect an unauthorized transaction by the malware 35 without affecting the existing communication protocol.

The automatic transaction system 50 (FIG. 1) of this embodiment equipped with this kind of transaction monitoring function according to this embodiment is now explained.

Foremost, the flow of the withdrawal processing performed in the automatic transaction system 50 of this embodiment is explained with reference to FIG. 4. As described above, with the automatic transaction system 50, because the accounting host computer 51 (FIG. 1) does not send the transaction information of the last transaction to the ATM 52 (FIG. 1) in the case of a normal transaction, in step S26, only the withdrawal command is sent from the accounting host computer 51 to the ATM 52. Moreover, in the ATM 52 that received the withdrawal command, the processing of step S29 and step S30 is omitted. The flow of the remaining processing is the same as the first embodiment.

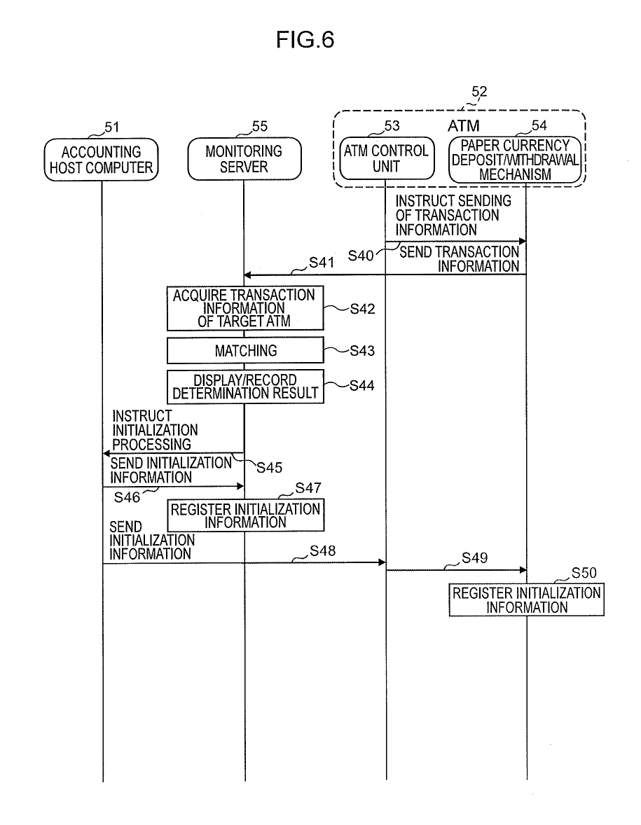

Details of the unauthorized command verification processing for verifying the existence of an unauthorized command at the timing that the detailed examination of the ATM 52 is performed are now explained with reference to FIG. 6. Foremost, the clerk to perform the detailed examination of the ATM 52 instructs the ATM 52 to send, to the monitoring server 55, the transaction information registered in the transaction information table 19 retained by the storage unit 18 of the paper currency deposit/withdrawal mechanism 54 by performing predetermined operations to the operation unit 11.

Subsequently, the ATM control unit 53 of the ATM 52 (ATM to be subject to detailed examination) that received the operational input instructs the paper currency deposit/withdrawal mechanism 54 to send, to the monitoring server 55, the transaction information registered in the transaction information table 19 (FIG. 1) retained by the storage unit 18 (FIG. 1) (S40). Consequently, the paper currency deposit/withdrawal mechanism 54 that received the foregoing instruction reads the transaction information for the period up to the time that the first initialization information appears retroactively from the latest transaction information (this is hereinafter referred to as the “verification target period”) among the transaction information registered in the transaction information table 19, and sends the read transaction information to the monitoring server 55 via the ATM control unit 53 (S41).

The monitoring server 55 that received the transaction information acquires necessary transaction information which is related to the ATM 52 to be subject to the detailed examination (this is hereinafter referred to as the “target ATM 52”) among the transaction information registered in the transaction information table 34 (FIG. 1) that it is managing (S42).

Specifically, the monitoring server 55 selects only the transaction information related to the target ATM 52 among the transaction information registered in the transaction information table 34, and, among the selected transaction information, further selects only the transaction information related to the respective transactions that were executed during the verification target period of the transaction information sent from the target ATM 52.

Subsequently, the monitoring server 55 sequentially determines whether or not the hash value included in each transaction information acquired in step S42 matches the hash value included in the corresponding transaction information among the transaction information sent from the target ATM 52 in step S41 (S43).

The monitoring server 55 displays the determination result of the foregoing determination and additionally records the determination result in a predetermined file (S44). Specifically, when the details of each piece of transaction information sent from the target ATM 52 all match the corresponding transaction information accumulated in the storage unit as a result of the foregoing determination, the monitoring server 55 determines that an unauthorized command was not issued during the verification target period, and displays that there was no fraudulence during the verification target period and additionally records such fact in a predetermined file.

Meanwhile, when the hash value included in any transaction information sent from the target ATM 52 did not match the hash value included in the corresponding transaction information registered in the transaction information table 34 as a result of the foregoing determination, the monitoring server 55 determines that an unauthorized command was issued during the verification target period, notifies an abnormality to the outside by displaying a warning or the like and additionally records such fact in a predetermined file.

The monitoring server 55 thereafter notifies the accounting host computer 51 that initialization should be executed (S45). Consequently, in accordance with the foregoing notification, in the same manner as step S6 to step S10 of FIG. 3, initialization information is sent from the accounting host computer 51 to the monitoring server 55 and the target ATM 52, and the initialization information is registered in the transaction information table 34 retained by the monitoring server 55, and in the transaction information table 19 retained by the paper currency deposit/withdrawal mechanism 54 of the target ATM 52, respectively (S46 to S50).

As described above, with the automatic transaction system 50 of this embodiment, the transaction information of the last transaction is not sent from the accounting host computer 51 to the ATM 52 during a normal withdrawal transaction, and the hash value included in the transaction information within a certain verification target period (period from the time that the cashbox door 16 of the cashbox 15 of the ATM 52 is opened to the time that the cashbox door 16 is thereafter opened once again) which is retained by the paper currency deposit/withdrawal mechanism 54 of the ATM 52 and the hash value included in the transaction information of the transactions executed by the ATM 52 within the verification target period which is retained by the monitoring server 55 are compared and verified at the timing that the detailed examination of the ATM 52 is performed.

Thus, according to the automatic transaction system 50, it is possible to verify whether or not cash was removed based on an unauthorized command during the certain verification target period while minimizing the amount of change in the communication protocol during a withdrawal transaction, and it is thereby possible to realize a highly reliable automatic transaction system.

### (3) Third Embodiment

If the storage unit 18 of the paper currency deposit/withdrawal mechanism 14, 54 of the ATM 2, 52 in the first or second embodiment is subject to a random failure and the transaction information stored in the storage unit 18 can no longer be read, it will not be possible to detect an unauthorized transaction caused by the malware 35 based on the methods described above in the first embodiment and the second embodiment.

Moreover, when the foregoing storage unit 18 is replaced with a new storage unit 18, because the new storage unit 18 does not store any past transaction information, it is necessary to execute the initialization processing described above with reference to FIG. 3 and complete the preparation of the transaction in order to enable the transaction based on the method of the first embodiment and the verification based on the method of the second embodiment.

This is because, for instance, in order to resume the transaction based on the method of the first embodiment, it is necessary to register the initialization information, which is the dummy transaction information as the transaction information of the last transaction, in the storage device 31 of the monitoring server 4 and in the storage unit 18 of the paper currency deposit/withdrawal mechanism 14 of the ATM 2, and, in order to perform the verification based on the method of the second embodiment, all transaction information during the verification period up to the time that the first initialization information appears retroactively from the latest transaction information needs to be accumulated in the storage unit 18 of the paper currency deposit/withdrawal mechanism 54 of the ATM 52. For example, in the case of FIG. 2, because the transaction in which the transaction number is “78901” is “initialization”, the transaction history to be compared/verified by the new storage unit 18 will newly be from the transaction information of “78901” onward excluding the transactions in which the transaction number is “34501” to “34505”.

Thus, if these events are used in an underhanded manner for fraudulently replacing or initializing the storage unit 18 of the paper currency deposit/withdrawal mechanism 14, 54 of the ATM 2, 52, past verification cannot be performed properly. Accordingly, a means for confirming that an authorized clerk is present upon replacing or initializing the storage unit 18 is required. Thus, provided is a means for confirming that the cashbox door 16 of the cashbox 15 is open during the initialization processing for confirming the presence of an authorized clerk allowed to open the cashbox door 16 of the cashbox 15 for storing cash to be protected by the ATM 2, 52.

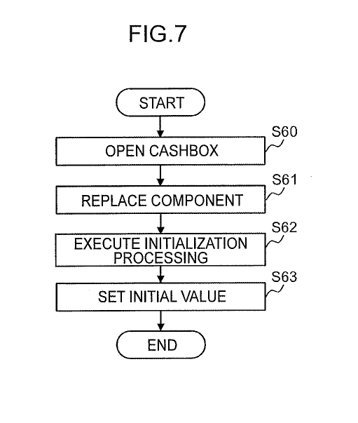

The routine of the replacement processing for replacing the storage unit 18 of the paper currency deposit/withdrawal mechanism 14, 54 of the ATM 2, 52 is now explained with reference to FIG. 7. Foremost, the cashbox door 16 of the cashbox 15 (FIG. 1) of the ATM 2, 52 is opened for replacing the storage unit 18 of the paper currency deposit/withdrawal mechanism 14, 54 of the ATM 2, 52 (S60). Next, the storage unit 18 is replaced (S61).

Because the newly installed storage unit 18 does not store transaction information, the initialization processing described above with reference to FIG. 3 is implemented by performing predetermined operations to the operation unit 11 (FIG. 1) of the ATM 2, 52 (S62). Note that, in order to implement the initialization processing as described above with reference to FIG. 3, the cashbox door 16 of the cashbox 15 must be open.

In other words, it is required that a clerk who is allowed to open the cashbox door 16 of the cashbox 15 is present for the replacement and initialization of the storage unit 18. Once the initialization processing is completed, the cashbox door 16 of the cashbox 15 is thereafter closed (S63).

It is thereby possible to properly set the range of the transaction information to be verified (verification target period) without any fraudulent replacement or initialization of the storage unit 18 of the paper currency deposit/withdrawal mechanism 14, 54 of the ATM 2, 52.

### (4) Fourth Embodiment

As described above, with the automatic transaction system 1 of the first embodiment, upon sending a withdrawal command to the ATM 2, because the accounting host computer 3 always sends the transaction information of the last transaction executed by the ATM 2 in addition to the withdrawal command, the amount of change in the existing communication protocol of the communication performed between the accounting host computer 3 and the respective ATMs 2 will increase.

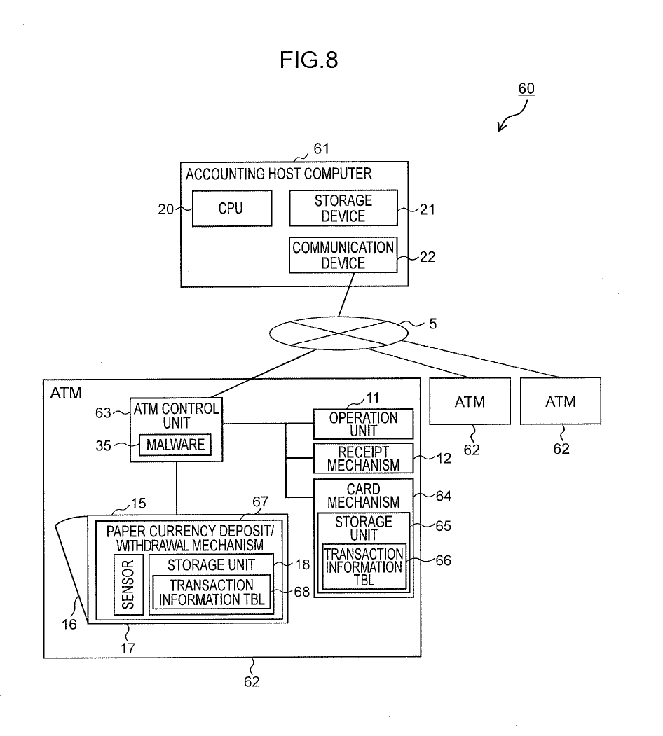

Thus, in this embodiment, as shown in FIG. 8 in which the same reference numeral is assigned to the corresponding component of FIG. 1, a storage unit 65 is provided to the card mechanism 64 of the ATM 62, the transaction information of the transactions executed in the ATM 62 is accumulated in the storage unit 65, and, by comparing/verifying the transaction information accumulated in the storage unit 65 and the transaction information accumulated in the storage unit 18 of the paper currency deposit/withdrawal mechanism 67, verification of the transaction information is enabled without affecting the communication protocol with the accounting host computer 61.

In effect, the automatic transaction system 60 according to this embodiment considerably differs from the automatic transaction system 1 of the first embodiment with respect to the point that the monitoring server 4 (FIG. 1) has been omitted, a storage unit 65 is provided within the card mechanism 64 of the ATM 62, the transaction information table 66 is stored in the storage unit 65, and an IC (Integrated Circuit) card is applied as the card medium to be handled by the card mechanism 64.

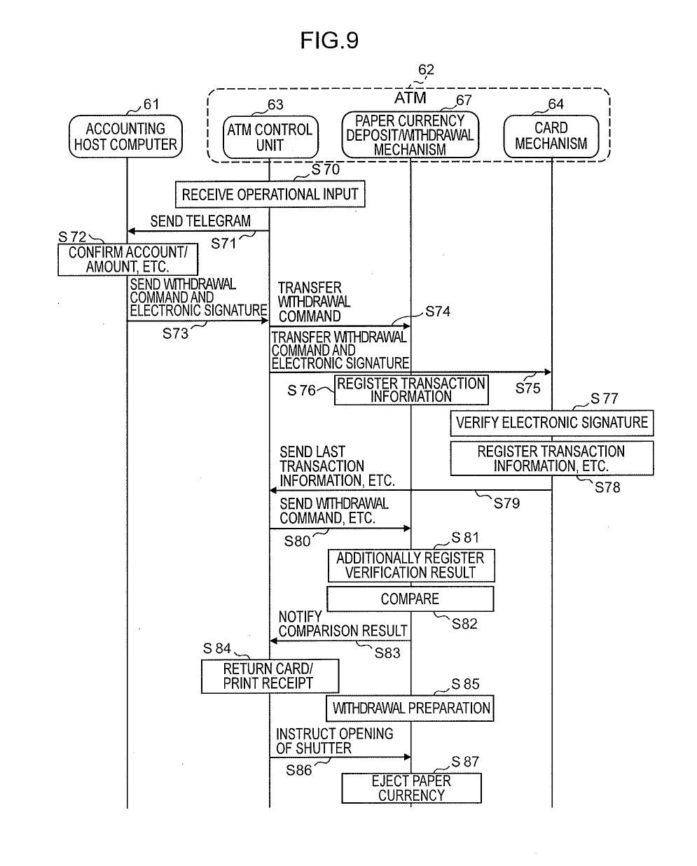

FIG. 9 shows the flow of the withdrawal transaction processing executed in the automatic transaction system 60 of this embodiment when a user performs a withdrawal transaction operation to the ATM 62. Because the handling of electronic signatures that appear in the ensuing explanation is compliant with the EMV specification and the same as those handled in general ATM transactions, the detailed explanation thereof is omitted in the ensuing explanation.

In FIG. 9, because the flow of step S70 to step S72 is the same as step S20 to step S22 of FIG. 4, the explanation thereof is omitted. However, in this embodiment, the card medium inserted by the user into the ATM 62 is an IC card.

Subsequently, the accounting host computer 61 sends a withdrawal command, and an electronic signature for verifying whether or not the withdrawal command is a legitimate command, to the target ATM 62 (ATM 62 that sent the telegram in step S71) (S73).

The ATM control unit 63 of the ATM 62 that received the withdrawal command and electronic signature transfers the withdrawal command to the paper currency deposit/withdrawal mechanism 67 (S74). Consequently, the paper currency deposit/withdrawal mechanism 67 extracts, from the withdrawal command, the transaction information of the current withdrawal transaction included in the withdrawal command, and registers the extracted transaction information in the transaction information table 68 stored in the storage unit 18 (S76).

Moreover, the ATM control unit 63 sends the received withdrawal command and electronic signature to the card mechanism 64 (S75). Subsequently, the card mechanism 64 verifies the received electronic signature by using the IC card (S77), and adds the verification result to the transaction information of the current withdrawal transaction included in the withdrawal command, and registers this in the transaction information table 66 stored in the storage unit 65. Moreover, the card mechanism 64 calculates the hash value of the transaction information based on information such as the store number and device ID included in the withdrawal command, and additionally registers the calculated hash value in the transaction information table 66 (S78). Note that, upon calculating the hash value, the electronic signature and the verification result of the electronic signature may also be included in the hash value.

The card mechanism 64 thereafter sends the transaction information of the last transaction executed by the ATM 62 which is registered in the transaction information table 66, and the verification result of the verification processing executed in step S77, to the ATM control unit 63 (S79).

When the verification result indicates that the electronic signature is false based on the verification result of the electronic signature sent from the card mechanism 64, the ATM control unit 63 cancels the current transaction and notifies an abnormality to the outside.

Meanwhile, when the electronic signature is correct, the ATM control unit 63 sends the withdrawal command sent from the accounting host computer 61 in step S73, and the transaction information of the last transaction (including the verification result of the electronic signature) sent from the card mechanism 64 in step S79, to the paper currency deposit/withdrawal mechanism 67 (S80).

Subsequently, the paper currency deposit/withdrawal mechanism 67 calculates the hash value of the current transaction in the same manner as the card mechanism 64 using the same hash function as the card mechanism 64 based on the transaction information of the current transaction included in the withdrawal command sent from the ATM control unit 63, and registers the new transaction information, to which the calculated hash value and the verification result of the electronic signature have been added, in the transaction information table 68 stored in the storage unit 18 (S81).

Moreover, the paper currency deposit/withdrawal mechanism 67 compares the hash value included in the transaction information of the last transaction registered in the transaction information table 66 stored in the storage unit 18, and the hash value included in the transaction information of the last transaction sent from the ATM control unit 63 in step S80 to verify whether or not they are a match (S82), and notifies the verification result to the ATM control unit 63 (S83). Moreover, the paper currency deposit/withdrawal mechanism 67 performs a withdrawal preparation of discharging, to the paper currency outlet (not shown), the paper currencies of the respective denominations designated in the withdrawal command in the number of denominations designated in the withdrawal command only when the two hash values are a match (S85).

Meanwhile, when the comparison result from the paper currency deposit/withdrawal mechanism 67 indicates that the two hash values are not a match, the ATM control unit 63 cancels the present transaction and notifies an abnormality to the outside.

Meanwhile, when the comparison result from the paper currency deposit/withdrawal mechanism 67 indicates that the two hash values are a match, the ATM control unit 63 controls the card mechanism 64 to return the user's card medium, which had been inserted, to the user, and controls the receipt mechanism 12 (FIG. 8) to print the details of the present transaction on a receipt (S84).

Furthermore, the ATM control unit 63 instructs the paper currency deposit/withdrawal mechanism 67 to open the shutter which is blocking the paper currency outlet (not shown) (S86). Consequently, the paper currency deposit/withdrawal mechanism 67 discharges the paper currencies by opening the shutter according to the foregoing instruction (S87), and thereafter closes the shutter once the paper currencies are removed by the user. The series of withdrawal processing is thereby ended.

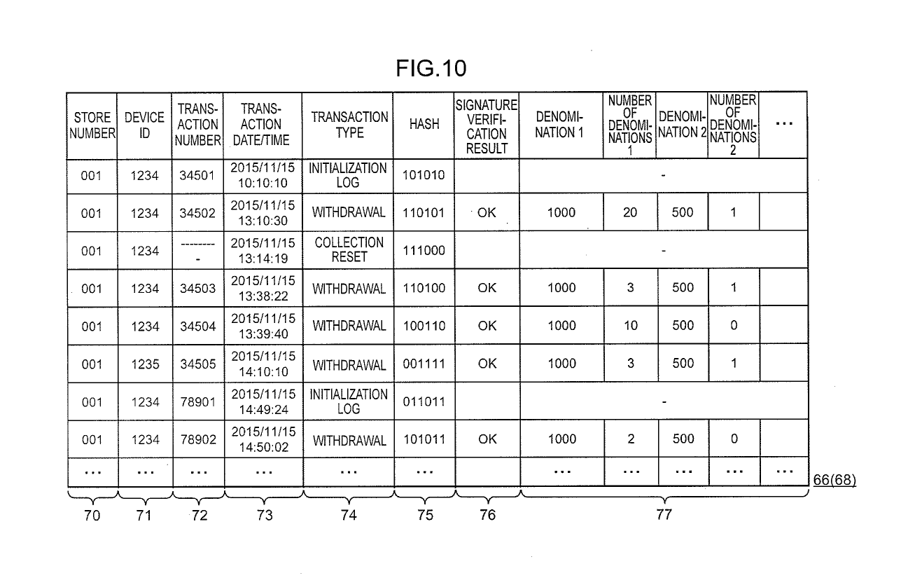

FIG. 10 shows the configuration of the transaction information table 66, 68 according to this embodiment which is retained by the storage unit 65 of the card mechanism 64 and the storage unit 18 of the paper currency deposit/withdrawal mechanism 67, respectively. The transaction information table 66, 68 is configured by comprising a store number column 70, a device ID (Identification) column 71, a transaction number column 72, a transaction date/time column 73, a transaction type column 74, a hash value column 75, a signature verification result column 76 and an amount column 77.

In the foregoing case, because the information respectively stored in the store number column 70, the device ID (Identification) column 71, the transaction number column 72, the transaction date/time column 73, the transaction type column 74, the hash value column 75 and the amount column 77 is the same as the information stored in the corresponding column of the transaction information table 19, 34 of the first embodiment described above with reference to FIG. 2, the explanation thereof is omitted. Moreover, the signature verification result column 76 stores the verification result of the verification of the electronic signature (step S77) that was executed by the card mechanism 64 in the corresponding transaction.

As described above, by recording the transaction information in the storage unit 65 of the card mechanism 64 for verifying the electronic signature, it is possible to record the correct transaction information without such transaction information being falsified, and, by comparing/verifying the foregoing transaction information and the transaction information in the paper currency deposit/withdrawal mechanism 67, sufficiently reliable verification can be performed within the ATM 62 without requiring the intervention of the accounting host computer 61. Note that, in order to further increase security, the electronic signature may also be recorded and verified in addition to including the verification result of the electronic signature in the transaction information.

### (5) Other Embodiments

Note that, in the first to fourth embodiments described above, a case where the transaction is a withdrawal transaction was only explained, but the present invention is not limited thereto, and it is also possible to similarly detect fraudulence in deposit transactions and bank transfer transactions, and the transactions are not particularly differentiated. In the foregoing case, because all transactions such as withdrawal transactions, deposit transactions and bank transfer transactions are registered in the transaction information table 19, 24, 66, the “last transaction” refers to the last transaction that was executed among all transactions executed in one specific ATM 2 among the plurality of ATMs 2 connected to the accounting host computer 3, 51 or the monitoring server 4, 55.

Moreover, in the first to fourth embodiments described above, a case of applying the transaction information of the last transaction was explained upon comparing the transaction information of the past transactions stored and retained in the storage unit 31 of the monitoring server 4, 55 and the storage unit 65 of the card mechanism 64 and the past transaction information stored and retained in the storage unit 18 of the paper currency deposit/withdrawal transaction unit 14, 54, 67, but the present invention is not limited thereto, and the transaction information of the second to the last transaction and older may also be applied. Moreover, a plurality of pieces of past transaction information may also be applied, rather than one piece of past transaction information, to be used upon performing the comparison.

Furthermore, in the first to third embodiments described above, a case was explained where the hash value of each transaction information is calculated by the monitoring server 4, 55 and the paper currency deposit/withdrawal mechanism 14, 54 of the ATM 2, 52 by using a common hash function, and the calculated hash values are compared to determine whether or not the details of the transaction information are the same, but the present invention is not limited thereto, and, for example, the hash values may be calculated in the accounting host computer 3, 51, or the determination of whether or not the details of the transaction information are the same may be performed by comparing the overall transaction information, and not the hash values, to determine whether or not the details are the same. Moreover, with regard to the generation of the hash values, the hash values may be generated by the paper currency deposit/withdrawal mechanism 14, the monitoring server 4, or the accounting host computer 3, 51 by using a part of the information among the store number, device ID, transaction number, transaction date/time, transaction type and amount of the transaction.

### INDUSTRIAL APPLICABILITY

The present invention can be broadly applied to automatic transaction systems of various configurations that handle paper currency.

### REFERENCE SIGNS LIST

1, 50, 60 . . . automatic transaction system, 2, 52, 62 . . . ATM, 3, 51, 61 . . . accounting host computer, 4, 55 . . . monitoring server, 10, 53, 63 . . . ATM control unit, 13, 64 . . . card mechanism, 14, 54, 67 . . . paper currency deposit/withdrawal mechanism, 15 . . . cashbox, 16 . . . cashbox door, 17 . . . sensor, 18, 65 . . . storage unit, 19, 34, 66, 68 . . . transaction information table, 31 . . . storage device.

1. An automatic transaction system which performs transactions using paper currencies, comprising:
an ATM control unit which sends first transaction information including first amount information as information related to an amount to be handled in a first transaction;
a paper currency handling device which receives the first transaction information and transfers paper currencies based on the first amount information included in the first transaction information;
a first storage unit which is provided in the paper currency handling device and which stores the first transaction information received by the paper currency handling device; and
a second storage unit which is provided in an external device outside the paper currency handling device and which stores the first transaction information received by the external device,
wherein, in a second transaction which is a transaction after the first transaction, the ATM control unit sends second transaction information including second amount information as information related to an amount to be handled in the second transaction,
the external device sends the first transaction information stored in the second storage unit, and
the paper currency handling device:
receives the second transaction information, and the first transaction information sent by the external device; and
determines whether or not the first transaction information stored in the first storage unit and the first transaction information sent by the external device are a match, and, when they are a match, transfers paper currencies based on the second amount information included in the second transaction information.

2. The automatic transaction system according to claim 1,
wherein the paper currency handling device and the external device respectively calculate a hash value by using a common hash function based on common information included in the first transaction information,
wherein a hash value calculated by the external device is included in the first transaction information sent by the external device in the second transaction, and
wherein a hash value calculated by the paper currency handling device is included in the corresponding first transaction information stored in the first storage unit.

3. The automatic transaction system according to claim 1,
transaction information including the first transaction information and the second transaction information includes at least one among a transaction number assigned to each transaction, a transaction date/time as a date/time of a transaction, a transaction type as a type of a transaction, and a number of paper currencies for each paper currency denomination to be handled in a transaction.

4. The automatic transaction system according to any one of claim 1, further comprising:
notification means which, when the first transaction information stored in the first storage unit and the first transaction information sent by the external device do not match in the second transaction, notifies the mismatch to a user or a clerk.

5. The automatic transaction system according to any one of claim 1,
wherein the ATM control unit and the paper currency handling device are provided within an automatic transaction device which performs deposit/withdrawal transactions according to a user's operational input,
wherein the automatic transaction system further comprises a host computer as an upper-level device of the automatic transaction device, and
wherein the host computer generates the first or second transaction information including a transaction number according to a processing request of the first or second transaction from the ATM control unit and sends the generated first or second transaction information to the external device and the ATM control unit.

6. The automatic transaction system according to any one of claim 1,
wherein the ATM control unit and the paper currency handling device are provided within an automatic transaction device which performs deposit/withdrawal transactions according to a user's operational input,
wherein the automatic transaction system further comprises a host computer as an upper-level device of the automatic transaction device,
wherein the host computer generates the first or second transaction information according to a processing request of the first or second transaction from the ATM control unit and sends the generated first or second transaction information to the external device and the ATM control unit, and
wherein the external device is a monitoring service provided separately from the automatic transaction device.

7. The automatic transaction system according to any one of claim 1,
wherein the external device is a card mechanism which verifies a first electronic signature related to the first transaction sent from an upper-level device of the ATM control unit by using an IC card,
wherein, in the first transaction,
the card mechanism stores the first transaction information received by the card mechanism in the second storage unit when a verification result of the first electronic signature is correct, and
wherein the paper currency handling device receives the verification result of the first electronic signature performed by the card mechanism, and stores the first transaction information received by the paper currency handling device in the first storage unit when the verification result of the first electronic signature is correct.

8. The automatic transaction system according to claim 7,
wherein the card mechanism verifies a second electronic signature related to the second transaction sent from an upper-level device of the ATM control unit by using an IC card, and
wherein the paper currency handling device receives the first transaction information sent by the card mechanism and determines whether or not the first transaction information stored in the first storage unit and the first transaction information sent by the card mechanism are a match when a verification result of the second electronic signature performed by the card mechanism is determined as being correct in the second transaction.

9. The automatic transaction system according to claim 1,
wherein the paper currency handling device comprises a cashbox which stores paper currencies, and a detection unit which detects an open/closed state of a door of the cashbox,
wherein the ATM control unit notifies a host computer as an upper-level device to execute initialization when the door of the cashbox is open,
wherein the host computer generates third transaction information as dummy transaction information according to the notification and sends the generated third transaction information to the external device and the ATM control unit,
wherein the external device stores the received third transaction information in the second storage unit,
wherein the ATM control unit sends the received third transaction information to the paper currency handling device, and
wherein, when the first storage unit has been replaced with a third storage unit as a new storage unit, the paper currency handling device stores the received third transaction information in the third storage unit.

10. The automatic transaction system according to claim 1,
wherein the paper currency handling device comprises a cashbox which stores paper currencies, and a detection unit which detects an open/closed state of a door of the cashbox,
wherein the ATM control unit notifies a host computer as an upper-level device to execute initialization when the door of the cashbox is open,
wherein the host computer generates third transaction information as dummy transaction information according to the notification and sends the generated third transaction information to the external device and the ATM control unit,
wherein the external device stores the received third transaction information in the second storage unit, and
wherein the paper currency handling device stores the received third transaction information in the first storage unit.

11. The automatic transaction system according to claim 10,
wherein the ATM control unit notifies the host computer to execute the initialization only while the detection unit of the paper currency handling device is detecting that the door of the cashbox is open.
